(19) United States
(12) Patent Application Publication
(10) Pub. No.: US 2023/0025007 A1
(43) Pub. Date: Jan. 26, 2023

(54) ACTIVE AIR CONDITIONING IN SLM PROCESSES

(71) Applicant: REALIZER GMBH, Borchen (DE)

(72) Inventors: Wadim RESCHETNIK, Lippstadt (DE); Guido ADAM, Paderborn (DE); Marc TIMMER, Paderborn (DE)

(73) Assignee: REALIZER GMBH, Borchen (DE)

(21) Appl. No.: 17/783,587

(22) PCT Filed: Dec. 7, 2020
(86) PCT No.: PCT/EP2020/084819

§ 371 Date: Jun. 8, 2022

(30) Foreign Application Priority Data
Dec. 12, 2019 (DE) 10 2019 219 417.6

(51) Int. Cl. B23K 26/12; B23K 26/34

(52) U.S. Cl. CPC B23K 26/123; B23K 26/34

(57) ABSTRACT

An apparatus for carrying out a method for producing an object using selective powder melting and by building up layers of powder material. The apparatus includes a build chamber configured to accommodate the object being produced and a powder delivery device equipped with a powder storage container and configured to supply material powder into the build chamber, a powder layer preparation unit to prepare successive layers of the supplied material powder on a substrate arranged in the build chamber, an irradiation device configured to irradiate a prepared powder layer to thereby melt the prepared powder layer locally, and a protective gas circulation device configured to circulate a protective gas present in the build chamber. At least one air conditioning device is also included and is configured to condition one or more of a temperature or a humidity of the protective gas circulated by the protective gas circulation device.

The present invention relates to an apparatus for carrying out a method for producing an object according to the process of selective powder melting by building up layers of a powder material, the apparatus comprising a build chamber which is configured to accommodate the object being produced, a powder delivery device which is equipped with a powder storage container and which is configured to supply material powder into the build chamber, a powder layer preparation unit which is configured to prepare successive layers of the supplied material powder on a substrate arranged in the build chamber, an irradiation device which is configured to irradiate a most-recently prepared powder layer and thereby melt it locally, and a protective gas circulation device which is configured to circulate a protective gas present in the build chamber.

In particular, the invention relates to an apparatus for producing shaped bodies according to the principle of selective laser melting or selective laser sintering. Regarding the prior art in the field of selective laser melting, reference should be made to DE 199 05 067 A1, DE 101 12 591 A1, WO 98/24574 A, DE 10 2009 038 165 A1, DE 10 2012 221 641 A1, EP 2 052 845 A2, DE 10 2005 014 483 A1, and WO 2017/084781 A1.

It is known that the process of selective laser melting can be used to produce shaped bodies such as machine parts, tools, prostheses, pieces of jewellery, etc. in accordance with geometric description data of the corresponding shaped bodies by building them up in layers proceeding from metallic or ceramic material powder, wherein, in a production process, multiple powder layers are successively applied one on top of the other, and each powder layer is heated with a focused laser beam in a specified region which corresponds to a selected cross-sectional area of the model of the shaped body, before the next powder layer is applied, such that the material powder in the irradiated regions is melted to form cohesively solidified sections.

The laser beam is guided over each of the powder layers in accordance with the geometric description data of the selected cross-sectional area of the shaped body, or optionally data derived therefrom.

In such processes of selective laser melting, the material powder is normally applied as a binder-free and flux-free, metallic, ceramic or mixed metallic/ceramic material powder, and is heated to its melting temperature by the laser beam, wherein the energy of the laser beam is selected in such a way that the material powder, at the location where the laser beam strikes it, is melted as completely as possible over its entire layer thickness, but, at the same time, the amount of heat introduced into the powder is not so high that adjacent regions of the powder would also be melted, which would lead to reduced precision in the production process and to undesirably high wall thicknesses of the produced object.

Above the zone of interaction between the laser beam and the material powder, an inert protective gas atmosphere, for example an argon atmosphere with increased pressure relative to the ambient pressure, is usually maintained to prevent oxidation of the material or other undesirable chemical reactions between the material and molecules from the atmosphere, and also to prevent the ingress of air from the environment. The protective gas used for this purpose is filtered in a gas circulation process, and returned to the build chamber.

In order to remove any residual moisture from the protective gas atmosphere which may still remain in the protective gas or in the material powder, the use of a purely passive gas drying device has been proposed for example in EP 2 992 986 A1, in which, for example, silica gel is present in a storage container in gas exchange with the protective gas atmosphere, and the silica gel removes moisture from the protective gas in a known manner. Furthermore, it has been proposed in WO 2017/220744 A1 to provide a drying gas flow by means of a separate gas system, which gas flow is guided through the build chamber in order to absorb moisture from an uppermost layer of the material powder.

However, it has been shown that these two proposed drying devices are inflexible in that they only act passively or in an uncontrolled manner, and therefore it is not possible to adjust defined process parameters of the protective gas atmosphere, or in that they are expensive and component-intensive due to the provision of the components for generating the drying gas flow.

Furthermore, it is also evident that the heating of the protective gas which always takes place due to the influence of the laser radiation is not eliminated by the two proposed drying devices, and can therefore continue to lead to thermal expansion of all components in the build chamber.

The process parameters of humidity and temperature of the protective gas which fluctuate in this way lead to a deterioration in the process stability and the quality of the component, since the humidity in the build chamber makes powder conveyance and processing significantly more difficult, for example by impairing its flowability, its coating, and its distribution. In addition, the powder conveyance into the build chamber may be impeded, which can also lead to the formation of agglomerates and to the cleavage of water from the remaining moisture in the atmosphere, which in extreme cases can lead to uncontrolled explosions and to the spattering of particles, or at least to a poorer surface quality of the component produced.

It is therefore the object of the present invention to develop an apparatus of the type in question for carrying out a process of selective powder melting in such a way that constant processing conditions can prevail in the build chamber, which can lead to improved component quality and to increased efficiency in the processes and in the production of corresponding objects.

To achieve this object, the apparatus according to the invention comprises at least one air conditioning device which is configured to condition, in an air conditioning operation, the temperature and/or humidity of the protective gas circulated by the gas circulation device. This not only overcomes the disadvantages of the prior art discussed above, but can also contribute to a reduction in the cooling power required for other machine components, such as optical components of the irradiation device, for example, and to faster cooling of hot powder, which in turn can increase cycle rates in the production of objects, and thereby increase the efficiency of the apparatus.

Furthermore, in the apparatus according to the invention, the protective gas circulation device can be configured to maintain an overpressure in the build chamber. Maintenance of a constant overpressure is also an operating parameter that can have a positive effect on the resulting component quality. Providing an overpressure prevents, among other things, the ingress of air from the environment.

According to the invention, the air conditioning device of the apparatus according to the invention can comprise a cooling unit for cooling the protective gas, in particular a heat exchanger, more particularly a counter-flow heat exchanger, wherein increased energy efficiency of the air conditioning device in its air conditioning operation is achieved in this way in a known manner. In such a counter-flow heat exchanger, in a first cooling stage, protective gas that has already been cooled is conveyed in a counter-flow to newly supplied protective gas to be cooled, such that a thermal coupling is established between these two gas flows.

In order to be able to carry out an air conditioning operation with regard to both the temperature of the protective gas and the moisture content thereof, the cooling unit can be assigned a condensate drainage system which is configured to discharge condensate which is produced due to the cooling of the protective gas. Care must be taken in this case to ensure that the condensate drainage system allows the condensate to be drained from the device without pressure losses; however, suitable drainage systems for this purpose are known to a person skilled in the art from the prior art.

Furthermore, the apparatus according to the invention can comprise a powder return for returning unmelted material powder to the powder storage container, which return forms part of the powder delivery device.

Alternatively or additionally, the powder delivery device can also preferably comprise at least one filter device for the material powder. Furthermore, the apparatus according to the invention can also comprise a powder extraction device which is configured to extract material powder remaining in the build chamber, and which comprises a circulating pump for this purpose, wherein a flow of protective gas driven by the circulating pump conveys the remaining material powder through a separator, in particular a cyclone separator.

Although different apparatuses for implementing the air conditioning operation of the air conditioning device are conceivable—such as intermittent operation with predetermined cycle times based on other process parameters, such as irradiation times—in a preferred embodiment, the air conditioning device can comprise a control unit which is configured to adapt parameters of the air conditioning operation. This control unit can be integrated into a higher-level control unit which controls further processes during the production of the object, or can be operationally coupled to it for data exchange.

In a further preferred embodiment, the apparatus can comprise at least one sensor unit which is operatively coupled to the control unit of the air conditioning device and is configured to supply data with respect to at least one process parameter of the apparatus. Because the sensor unit measures for example a temperature or humidity of the protective gas at a suitable point in the protective gas circulation device, and outputs corresponding data to the control unit, a control circuit can be created for this at least one process parameter or one or more process parameters derived from it, which control circuit allows optimised operation and practically arbitrarily precise adjustment of the corresponding process parameters over time. As already indicated, the at least one process parameter can thus include a temperature and/or a relative or absolute humidity of the protective gas.

Although the at least one air conditioning device could be provided in a wide variety of positions in the apparatus according to the invention, it can be at least partially arranged in the build chamber, or in the powder storage container, or in a gas line which is part of the protective gas circulation device, or in a gas or powder line which is part of the powder circuit, or in a gas line which is part of the powder extraction device, in order to condition the protective gas therein.

Further features and advantages of the present invention will become even clearer from the following description of an embodiment, when said embodiment is considered together with the accompanying drawings, in which:

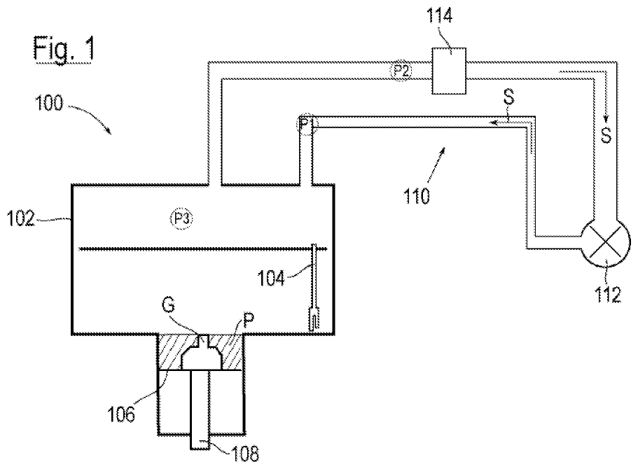

FIG. 1 is a schematic illustration of a protective gas circulation device in an embodiment of an apparatus according to the invention;

FIG. 2 is a schematic illustration of a powder extraction device in an embodiment of an apparatus according to the invention;

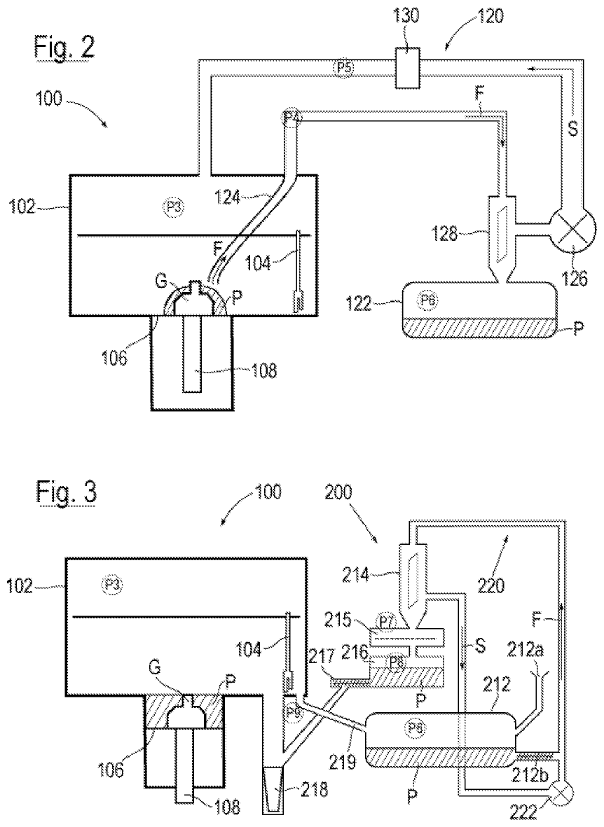

FIG. 3 is a schematic illustration of a powder supply device in an embodiment of an apparatus according to the invention; and

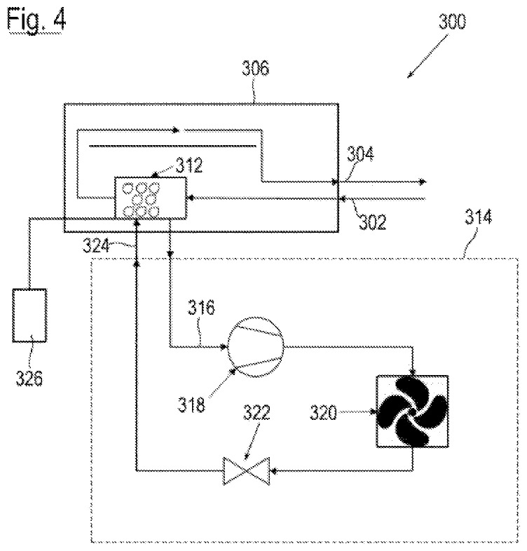

FIG. 4 is a schematic illustration of a possible embodiment of an air conditioning device from the apparatus of FIGS. 1 to 3.

A schematic illustration of an embodiment of an apparatus according to the invention is shown in a cross-sectional view in each of FIGS. 1 to 3, and is designated as a whole by reference sign 100. Different circuits are shown in FIGS. 1 to 3, but these are used in the same apparatus 100 and have only been divided between FIGS. 1 to 3 for reasons of clarity.

The apparatus 100 comprises a build chamber 102 which accommodates an object G being produced, which object is produced by the method of selective powder melting by building it up in layers from a powder material P, wherein a protective atmosphere with elevated pressure prevails in the build chamber 102.

The irradiation device used to produce the object G is not shown in FIGS. 1 to 3, for reasons of clarity; however, a powder layer preparation device 104 is provided in the build chamber 102, and is configured to prepare sequential layers of supplied material powder P on a substrate 106 arranged in the build chamber 102.

This substrate 106 is accommodated in the build chamber 102 in a manner allowing height adjustment by a lifting device 108, which is shown in rough, schematic form. In the state shown in FIG. 1, it is presently held at such a height that the powder P prepared by the powder layer preparation device 104 is spread out at a suitable level for a subsequent, further irradiation step which serves the purpose of building up a further layer of the object G.

Furthermore, FIG. 1 shows a protective gas circulation device 110 in which a protective gas flow is driven by a circulating pump 112, which flow is indicated schematically by the arrows S. The protective gas circulated by the protective gas circulation device 110 is maintained at an overpressure relative to the environment of the apparatus 100, and the protective gas circulation device 110 removes flue gas and spatter particles from the build chamber 102. These can be collected in a filter 114 through which the gas to be circulated passes in the circulation device 110.

Since heat is introduced into the build chamber 102 as a result of the process during operation of the irradiation device (not shown), the protective gas circulating in the apparatus 100 will inevitably heat up—this also applies to numerous other components of the apparatus 100. Since such heating of components of the apparatus 100 will lead to a thermal expansion of these components, the accuracy of the production process of the object G in the apparatus 100 can suffer as a result. Because of this, cooling of various components, such as individual components of the irradiation device itself, is known in the prior art. Furthermore, it has been shown that moisture remaining in the protective gas or the material powder can also lead to deterioration of the objects G produced in the apparatus 100.

According to the invention, the apparatus 100 of FIGS. 1 to 3 therefore comprises at least one of the air conditioning devices described below in conjunction with FIG. 4, which can first of all be provided at various positions in the apparatus 100 of FIG. 1, for example in the protective gas circulation device 110 behind the circulating pump, i.e. at the position indicated with P1, at a position P2 inside the protective gas circulation device 110, in front of the filter 114, or directly assigned to the build chamber 102, i.e. at position P3. In this case, position P1 is preferred to position P2, since the protective gas flow at position P1 is better suited for cooling operation than at position P2, where the protective gas flow can still contain impurities that could damage the air conditioning device.

Furthermore, at least one sensor unit can be operationally assigned to the air conditioning device, which unit, in a known manner, supplies data regarding at least one process parameter, for example a temperature and/or a relative humidity or absolute humidity of the protective gas, to a control unit (not shown) of the air conditioning device so as to establish a control loop. This at least one sensor unit can also be provided at one of the three positions P1 to P3 within the apparatus 100, for example.

FIG. 2 now shows a powder extraction device 120 which also forms part of the apparatus 100. By means of this powder extraction device 120, after the end of the production process of the object G, an operator can extract remaining material powder P in the build chamber 102 that was not melted during the production process, and return it to a powder storage container 122. In order to illustrate that in FIG. 2 the production process of the object G is substantially complete, in the state shown there the lifting device 108 has raised the substrate 106 into an upper stop position, and the object G is now ready to be removed from the build chamber 102.

For the process of extracting the remaining powder, on the one hand an extraction hose 124 is provided inside the build chamber 102 and can be guided by the operator from outside the build chamber 102 to the material powder P to be extracted, and on the other hand, a circulating pump 126 is provided which draws protective gas from the build chamber 102 and thus generates a gas flow which results in the extraction of the material powder P. The material powder extracted in this way and following the arrow F is guided through a cyclone separator 128 in which it is separated from the gas flow and collects in the powder storage container 122.

A filter 130 can also be assigned to the powder extraction device 120, as can at least one of the air conditioning devices described below in connection with FIG. 4, which accordingly can also be provided at further positions P4 and P5 inside the powder extraction device 120, in addition to position P3 inside the build chamber 102 as mentioned above, wherein position P5 again is preferred to position P4 since already-filtered protective gas arrives at it, or at position P6 within the powder storage container 122.

FIG. 3 also shows a schematic illustration of the powder supply device 200 of the apparatus 100 according to the invention. Here again, the build chamber 102 is shown with the powder layer preparation device 104 provided therein, and with an irradiation device (not shown).

In the build chamber 102, an object G made of a material powder P has also already been built up on the substrate 106, but the production of the object G is not yet fully completed, analogously to FIG. 1, so that the lifting device 108 again holds the substrate 106 at the height shown in FIG. 1.

In addition to a powder storage container 212, which can be identical to the powder storage container 122 already mentioned above, and a cyclone separator 214, the powder delivery device 200 also includes an ultrasonic sieve 215 for sieving the material powder to be supplied, a buffer container 216 with an associated screw conveyor 217 for the sieved material powder, and a loading unit 218 which ultimately feeds the material powder supplied by the screw conveyor 217 from below into the build chamber 102, where it is then prepared by the preparation device 104 for a subsequent irradiation step.

Furthermore, the powder delivery device 200 comprises a powder return 219 through which material powder that has not been melted in an irradiation process can be transferred back to the powder storage container 212, and consequently, in a subsequent step of re-supply into the build chamber 102, after again passing through the cyclone separator 214, the ultrasonic sieve 215, the buffer tank 216 and the screw conveyor 217, is guided again into the build chamber 102 by the loading unit 218. In addition, the powder storage container 212 is assigned a refilling device 212a through which material powder can be fed into the powder storage container 212 during ongoing operation of the device 200.

The powder delivery device 200 is again coupled to a protective gas circulation device 220, specifically in such a way that the protective gas circulated by a circulating pump 222, the flow of which is indicated by the arrow S, carries the material powder which is conveyed by a screw conveyor 212b out of the powder storage container 212, as indicated by the arrow F, to the cyclone separator 214.

At least one air conditioning device as shown in FIG. 4 can also be provided in the powder delivery device 200 of FIG. 3 to condition the protective gas, it being possible for this air conditioning device to be likewise provided at different points in the powder delivery device 200—for example, also at a point P6 in the powder storage container 212 or a point P3 inside the build chamber 102.

In addition to these possible positions for the air conditioning device already mentioned above in conjunction with FIGS. 1 and 2, it could also be located in FIG. 3 in the region of the ultrasonic sieve 215 at a position P7, at a position P8 assigned to the buffer container 216, or at a position P9 assigned to the loading device 218 or the powder return 219.

Again, the positions P1 to P9 mentioned can also or alternatively serve as installation positions for at least one sensor unit for detecting at least one process parameter, for example the temperature and/or the moisture content of the protective gas.

A possible embodiment of an air conditioning device is shown schematically in FIG. 4, indicated overall by reference sign 300. In this case, warm and humid protective gas is fed into a counter-flow heat exchanger 306 at a point 302, and temperature-controlled, dry protective gas is removed from this heat exchanger 306 again at point 304 after the heat exchanger has undertaken a first pre-cooling of the warm and humid protective gas according to the counter-flow principle.

The heat exchanger 306 is also assigned a cooling circuit 314 coupled via a cooling unit 312, as is known from the prior art, in which cooling circuit a heated coolant is initially compressed and heated at point 316 by a compressor 318, and then cooled by a cooler 320 and liquefied. Subsequently, the cooled coolant is decompressed by a throttle 322 and is thereby cooled considerably further. With the coolant thus cooled acting on the pre-cooled protective gas flow at point 324, the latter also cools down and can be sent to point 304 as a dry and cold gas flow, and moisture originally present therein will condense in the region of the cooling unit 312. This condensed moisture can be removed from the air conditioning device 300 by a condensate drainage system 326, which is also known from the prior art, without protective gas being able to escape from the apparatus or gas from outside being able to penetrate the apparatus.

The protective gas flow can be conditioned in this way, and this is carried out by the heat exchanger 306 and the cooling unit 312, which consequently act together as a cooling unit within the meaning of the present invention. Process parameters, such as the temperature or the cooling power of the coolant of the cooling circuit, can be adjusted by a control device (not shown) of the air conditioning device 300, for example, using sensor units supplying the above-mentioned sensor data. By way of example, an increased detected temperature of the protective gas at one of the measuring points can lead to the control unit of the air conditioning device increasing the cooling power of the cooling circuit.

The active air conditioning of protective gases in apparatuses for carrying out a method for producing an object using the process of selective powder melting, as described here, allows excellent adjustment of the relevant process parameters of temperature and humidity of the protective gas inside the build chamber 102, and thus makes it possible to achieve improved accuracy and increased efficiency of the production process.

1. An apparatus for carrying out a method for producing an object according to the process of selective powder melting, by building up layers of powder material, the apparatus comprising:
a build chamber configured to accommodate the object being produced;
a powder delivery device equipped with a powder storage container and configured to supply material powder into the build chamber;
a powder layer preparation unit configured to prepare successive layers of the supplied material powder on a substrate arranged in the build chamber (102);
an irradiation device configured to irradiate a prepared powder layer and thereby melt the prepared powder layer locally;
a protective gas circulation device configured to circulate a protective gas present in the build chamber; and
at least one air conditioning device configured to condition, in an air conditioning operation, one or more of a temperature or a humidity of the protective gas circulated by the protective gas circulation device.

2. The apparatus of claim 1, wherein the protective gas circulation device is further configured to maintain an overpressure in the build chamber.

3. The apparatus of claim 1, wherein the air conditioning device comprises a cooling unit for cooling the protective gas.

4. The apparatus of claim 3, wherein the cooling unit is assigned a condensate discharge system configured to discharge condensate produced due to the cooling of the protective gas.

5. The apparatus of claim 1, further comprising a powder return for returning unmelted material powder to the powder storage container, wherein the powder return forms part of the powder delivery device.

6. The apparatus of claim 1, wherein the powder delivery device further comprises at least one filter device for the material powder.

7. The apparatus of claim 1, further comprising a powder extraction device configured to extract material powder remaining in the build chamber, the powder extraction device comprising a circulating pump for extracting the material powder remaining in the build chamber, wherein a flow of protective gas driven by the circulating pump conveys the remaining material powder through a separator.

8. The apparatus of claim 1, wherein the air conditioning device comprises a control unit configured to adapt parameters of the air conditioning operation.

9. The apparatus of claim 8, further comprising at least one sensor unit which is operatively coupled to the control unit of the air conditioning device and is configured to supply data relating to at least one process parameter of the apparatus.

10. The apparatus of claim 9, wherein the at least one process parameter includes one or more of (A) a temperature or (B) a relative or absolute humidity of the protective gas.

11. The apparatus of claim 1, wherein the at least one air conditioning device is at least partially arranged in the build chamber, in order to condition the protective gas therein.

12. The apparatus of claim 1, wherein the at least one air conditioning device is at least partially arranged in the powder storage container in order to condition the protective gas therein.

13. The apparatus of claim 1, wherein the at least one air conditioning device is at least partially arranged in a gas line which is part of the protective gas circulation device in order to condition the protective gas therein.

14. The apparatus of claim 1, wherein the at least one air conditioning device is at least partially arranged in a gas or powder line which is part of the powder delivery device in order to condition the protective gas therein.

15. The apparatus of claim 1, wherein the at least one air conditioning device is at least partially arranged in in a gas line which is part of the powder extraction device in order to condition the protective gas therein.

16. The apparatus of claim 3, wherein the cooling unit comprises a heat exchanger.

17. The apparatus of claim 16, wherein the heat exchanger comprises a counter-flow heat exchange.

18. The apparatus of claim 7, wherein the separator comprises a cyclone separator.
